(19) United States
(12) Patent Application Publication
(10) Pub. No.: US 2022/0079387 A1
(43) Pub. Date: Mar. 17, 2022

(54) COOKING APPARATUS

(71) Applicant: Nelson Shen, Dongguan City (CN)

(72) Inventor: Nelson Shen, Dongguan City (CN)

(21) Appl. No.: 17/022,084

(22) Filed: Sep. 16, 2020

(51) Int. Cl. A47J 44/00; A47J 36/32; A47J 37/06; A47J 37/07; A47J 36/38; F24C 7/10; F24C 7/00

(52) U.S. Cl. CPC A47J 44/00; A47J 36/32; A47J 37/0641; F24C 7/002; A47J 36/38; F24C 7/105; A47J 37/0713

(57) ABSTRACT

A cooking apparatus includes three cooking modules supported on a cart. The first cooking module is a barbecue grill or a teppanyaki device. The second cooking module is an electric oven. The third cooking module is an air fryer. The air fryer includes a casing and a drawer. The casing is inserted in the cart in a non-movable manner. The drawer is movable into and from the casing.

### BACKGROUND OF INVENTION

### 1. Field of Invention

The present invention relates to a cooking apparatus and, more particularly, to a cooking apparatus operable to cook like an air fryer.

### 2. Related Prior Art

There are various cooking apparatuses. For example, an air fryer is operable to convert electricity into heat and provide a cyclone of air to transfer the heat. Thus, without having to use much grease, oil or juice, the air fryer cooks food so that the food tastes like it is fried. Such cooking allows a user to enjoy a great flavor of the food without having to observe much grease, oil or juice. That is, the air flyer provides the user with delicious and healthy food. However, a conventional air fryer is equipped with a motor that is actuated with electricity. Hence, the conventional air fryer is not suitable for outdoor use.

The present invention is therefore intended to obviate or at least alleviate the problems encountered in the prior art.

### SUMMARY OF INVENTION

It is the primary objective of the present invention to provide a cooking apparatus operable to cook like an air flyer.

To achieve the foregoing objective, the cooking apparatus includes a cart, a casing, a top plate, a protuberance, a fan, a motor, a burning can, a connective pipe, a burner, a valve, a power knob and an igniter. The cart includes plates connected to a control panel to provide a compartment. The control panel includes an opening. The casing includes an open top. The casing is inserted in the compartment in a non-movable manner. The top plate covers the open top of the casing to provide a frying chamber in the casing. The frying chamber includes an entrance in communication with the opening of the control panel. The protuberance is formed on a central portion of the top plate. The fan is located under the protuberance. The motor is connected to the fan and supported on the protuberance. The burning can is attached to the top plate out of the casing in a non-movable manner. The connective pipe includes an end connected to the protuberance and another end connected to the burning can. The burner includes an end connected to the burning can. The valve is connected to another end of the burner. The power knob is connected to the valve and located out of the control panel. The igniter is connected to the burning can in the vicinity of the burner. The power knob is operable to actuate the igniter.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a cooking apparatus according to the preferred embodiment of the present invention;

FIG. 2 is a cut-away view of the cooking apparatus shown in FIG. 1;

FIG. 3 is a partial view of the cooking apparatus depicted in FIG. 1;

FIG. 4 is another partial view of the cooking apparatus shown in FIG. 3;

FIG. 5 is a side view of the cooking apparatus shown in FIG. 4;

FIG. 6 is a left side view of the cooking apparatus shown in FIG. 4; and

FIG. 7 is another cut-away view of the cooking apparatus shown in FIG. 4.

### DETAILED DESCRIPTION OF PREFERRED EMBODIMENT

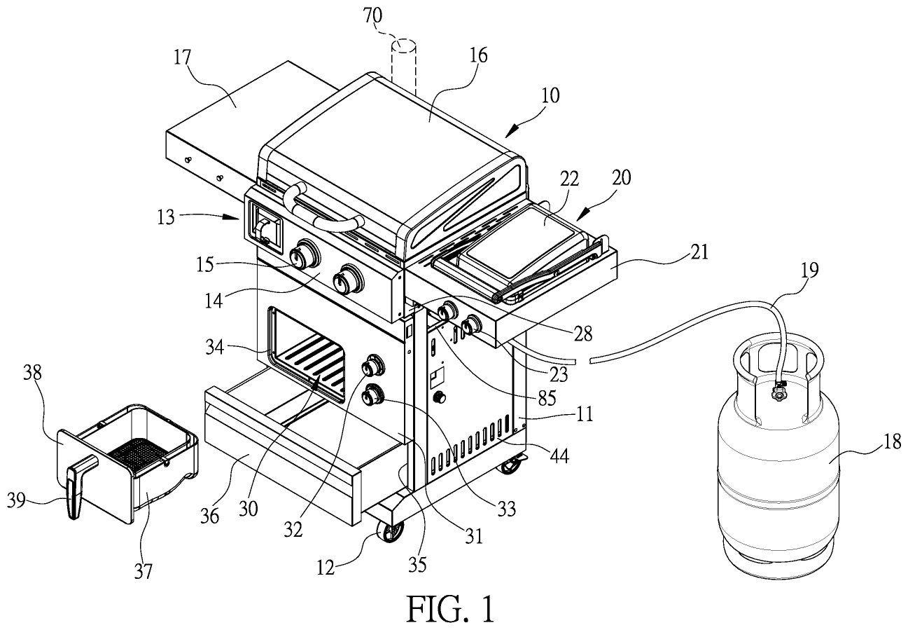

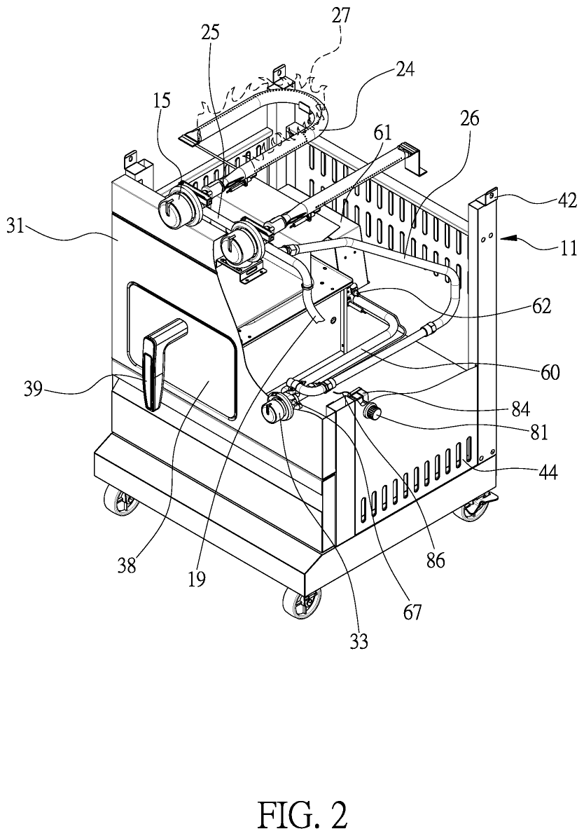

Referring to FIGS. 1 and 2, a cooking apparatus 10 includes a cart 11 for supporting three cooking modules 13, 20 and 30 according to the preferred embodiment of the present invention. The cooking module 13 includes a casing 28 connected to an upper portion of the cart 11 by multiple connectors 42.

A lid 16 is pivotally connected to the casing 28 so that the lid 16 is movable between a lifted position and a lowered position. In the lifted position, the lid 16 is opens the cooking module 13 to allow food to be put into or onto the cooking module 13 so that the food can be cooked in or on the cooking module 13. In the lowered position, the lid 16 closes the cooking module 13 to protect the cooking module 13 from contaminants such as dust or dirt.

Two burners 24 are inserted in the casing 28 for example. One of the burners 24 is a rectilinear pipe formed with orifices while the other burner 24 is a U-shaped pipe formed with orifices. Each of the burners 24 includes an end connected to a knob 15 so that the burners 24 are controlled by the knobs 15. The knobs 15 are inserted in front of a control panel 14 of the casing 28. Each of the knob 15 is operable to control a valve (not shown) arranged between the corresponding burner 24 and a common fuel tank 18. Fuel can be ignited at each of the burners 24 to provide a flame 27. The knobs 15 are operable to control the valves to control the flames 27. The fuel tank 18 is connected to the burners 24 via a fuel pipe 19 and an inlet pipe 25. The fuel pipe 19 substantially extends out of the casing 28. The inlet pipe 25 extends in the casing 28. The fuel pipe 19 is connected to the inlet pipe 25.

The cooking module 13 can be used as a teppanyaki device if a metal plate is used above the burners 24. The cooking module 13 can be used a barbecue grill if a grid is located used the burners 24.

The casing 28 includes two side boards 17 and 21. The food can be washed, wind-dried, cut and/or peeled on the side boards 17 and 21 for example.

The cooking module 20 is preferably an electric oven supported on the side board 21, on a side of the cooking module 13. The cooking module 20 is operable to convert electricity into heat for cooking. Two operation knobs 23 are inserted in front of the side board 21. At least one of the operation knobs 23 is used to change efficiency of the conversion to change intensity of the heat. A lid 22 is used to cover the cooking module 20 so that the former protects the latter from contaminants such as dust or dirt.

The cooking module 20 can be an induction cooker based on induction heating for cooking in another embodiment.

The cooking module 20 can be a gas stove connected to the fuel tank 18 via the fuel pipe 19.

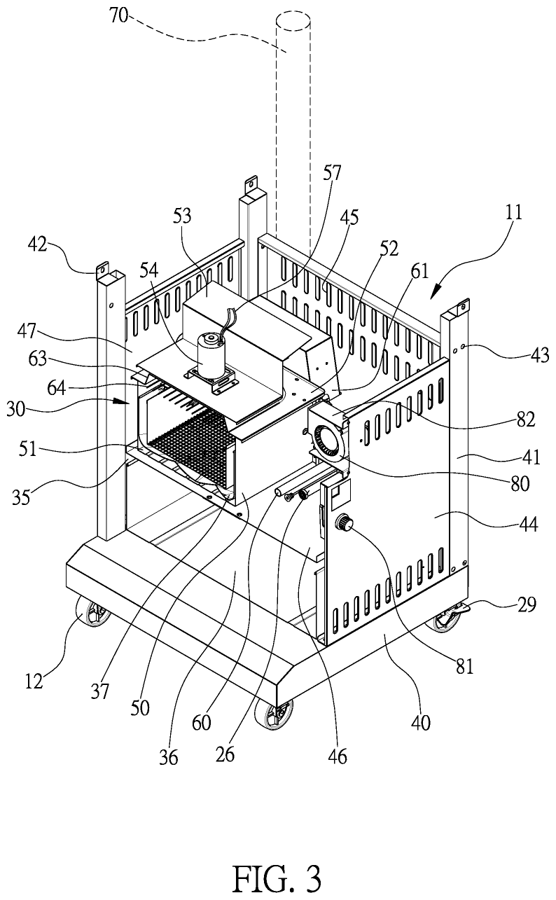

Referring to FIG. 3, the cart 11 includes four posts 41 at four corners, respectively. An upper end of each of the posts 41 is connected to one of the connectors 42 by welding for example. A lower end of each of the posts 41 is connected to an upper face of a chassis 40 of the cart 11. The cart 11 includes casters 12 connected to a lower face of the chassis 40. The casters 12 allow easy movement of the cooking apparatus 10 on a floor. The cart 11 of the cooking apparatus 10 includes a brake system 29 for braking the casters 12 to keep the cart 11 of the cooking apparatus 10 still.

The cart 11 includes three plates 44 each of which is located between two adjacent ones of the posts 41. Each of the plates 44 is connected to the corresponding posts 41 by multiple fasteners 43 to reinforce the cart 11. The plates 44 are made with height smaller than that of the posts 41 so that there is a gap 85 between the casing 28 and each of the plates 44. However, in another embodiment, the height of the plates 44 can be identical to the height of the posts 41 so that there is no gap 85 between the casing 28 and each of the plates 44.

A partition 46 is inserted in a space of the cart 11 that is defined by the plates 44. The partition 46 extends horizontally to divide the space of the cart 11 into a lower compartment 35 and an upper compartment 47. The lower compartment 35 is inserted in the vicinity of the chassis 40 and used to receive a drawer 36. A control panel 31 is connected to two adjacent ones of the posts 41 by welding, between the control panel 14 and the drawer 36. The control panel 31 and the plates 44 extend around the upper compartment 47.

The drawer 36 is used to receive tableware and cooking utensil such as bowls, chopsticks, spoons and a lighter. Normally, the drawer 36 is inserted in the lower compartment 35 to store the tableware and the cooking utensil. The drawer 36 can be moved out of the lower compartment 35 to allow the tableware and the cooking utensil to be moved from the drawer 36 for use.

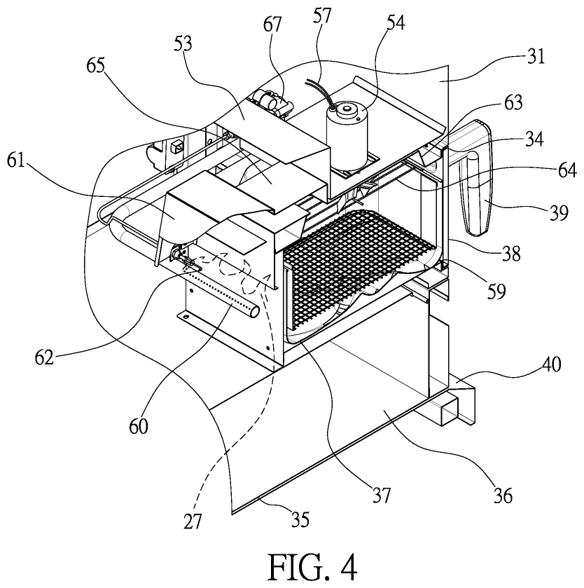

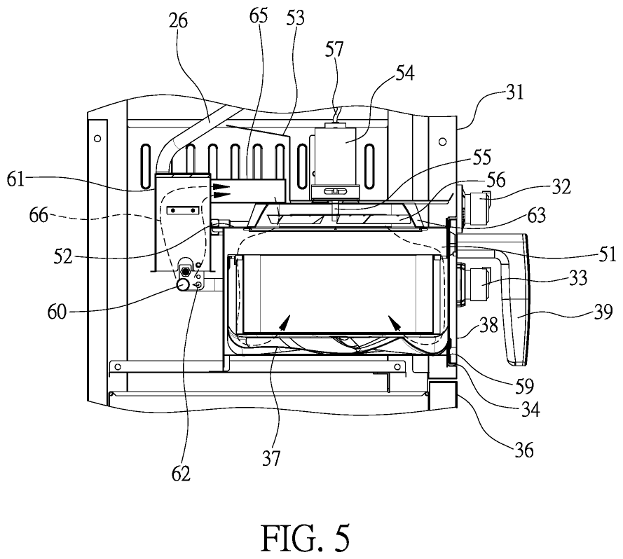

Referring to FIGS. 3 to 5, the cooking module 30 is an air fryer that includes a pot 37, a casing 50, a frying chamber 51, a top plate 52, a motor 54 and a fan 56. The pot 37 includes a handle 39 connected to a front panel 38. The handle 39 is operable to maneuver the pot 37.

The casing 50 includes a bottom connected to the partition 46 by welding and an open top covered by the top plate 52. The frying chamber 51 is a space defined by the combination of the top plate 52 with the casing 50. The flying chamber 51 includes an entrance 59 in communication with an opening 34 of the control panel 31. Thus, the front panel 38 covers the opening 34 (or the entrance 59). The pot 37 can be moved deeply into the frying chamber 51 through the entrance 59 and the opening 34 of the control panel 31.

The top plate 52 includes a protuberance 63 extending from a central portion. The protuberance 63 covers the fan 56. The fan 56 is separated from the flying chamber 51 by a grid or net 64. Preferably, the grid or net 64 is a metal grid inserted in the casing 50 or the top plate 52. The protuberance 63 is in communication with the flying chamber 51 via apertures or slots in the grid or net 64.

The motor 54 is supported on a stepped plate 53 that is connected to the protuberance 63. The motor 54 includes a mandrel 55 extending through the stepped plate 53 and the protuberance 63. The mandrel 55 is connected to the fan 56. Thus, the motor 54 keeps the fan 56 above the grid or net 64.

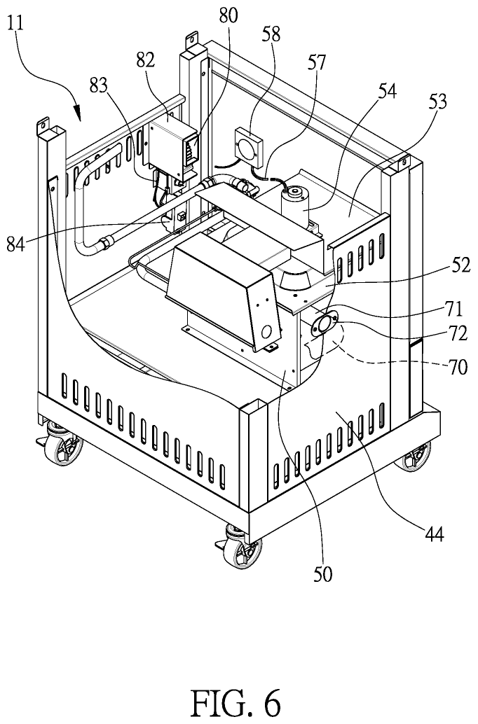

Referring to FIGS. 1, 3 and 6, the cooking module 30 is equipped with a cooler that includes a blower 80 and a control system. The control system includes a time knob 32 supported on an external face of the control panel 31. The time knob 32 is connected to a regulator 58 supported on an internal face of the control panel 31. The regulator 58 is electrically connected to the motor 54 via a wire 57 and electrically connected to the blower 80 via another wire 83. Thus, the time knob 32 is operable to turn on the fan 56 and the blower 80 at a same time.

The blower 80 is supported on a supporting element 82 that is connected to an internal face of one of the plates 44. The supporting element 82 guides air propelled by the blower 80 to the motor 54. The air propelled by the blower 80 sweeps the motor 54 and leaves the cart 11 via multiple apertures 45 made in the plates 44 to enhance heat convection in the upper compartment 47 and lower temperature around the motor 54.

Referring to FIGS. 3 to 5, the cooking module 30 is equipped with a heater that includes a manifold 26, a burner 60, a burning can 61, an igniter 62 and a connective pipe 65. The burning can 61 includes an end connected to the top plate 52 by welding and another end connected to a rear face of the casing 50. The connective pipe 65 includes an end connected to the protuberance 63 and another end located above the burning can 61. The burner 60 includes an end connected to a bottom of the burning can 61 and another end connected to a valve 67. The burner 60 extends along a curve in the vicinity of the casing 50.

The igniter 62 is attached to the bottom of the burning can 61, in the vicinity of the burner 60. The igniter 62 is electrically connected to a power knob 33 that is located in front of a control panel 31. The power knob 33 is operable to cause the igniter 62 to generate a spark and control the valve 67 to control the rate of the fuel into the burner 60. The manifold 26 includes an end connected to the valve 67 and another end connected to the inlet pipe 25 (FIG. 2). The valve 67 guides the fuel to the burner 60 where the fuel is ignited by the spark to generate a flame. That is, the power knob 33 is operable to control the intensity of the flame.

The burner 60 burns the fuel to heat the ambient air. The heated air ascends in the top of the burning can 61, turns to the connective pipe 65 as indicated by an arrow head 66, goes into the protuberance 63, and finally enters the frying chamber 51 via the grid or net 64. The heated air becomes a cyclone in the pot 37. Thus, the heated air cooks food like so that the food tastes like it is fried even though no oil or grease is used.

Referring to FIG. 2, a cap 81 is attached to the external face of one of the plates 44. The cap 81 can be detached from the corresponding plate 44 to open a battery chamber 84 to allow a used battery to be replaced with a new one. The battery is electrically connected to the power knob 33 via another wire 86. The power knob 33 is operable to cause the igniter 62 to generate a spark.

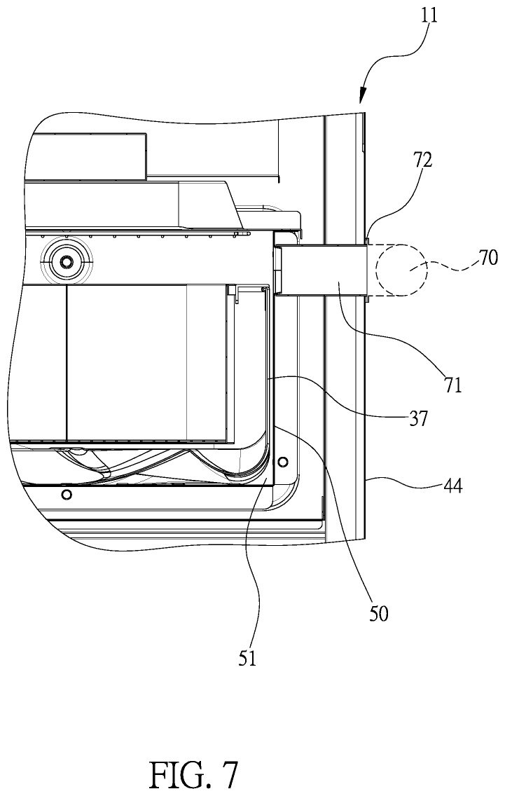

Referring to FIGS. 1, 3, 6 and 7, the cooking module 30 is equipped with a relief mechanism that includes a chimney 70 and an exhaust pipe 71. The exhaust pipe 71 is a rectilinear pipe that includes an end connected to the flying chamber 51 and another end formed with a flange 72 connected to one of the plates 44. The flange 72 is connected to an inlet end of the chimney 70. The chimney 70 includes an outlet end located out of the cart 11 as long as it does not interfere with the operation and/or movement of the cooking apparatus 10.

The cyclone of heated air in the pot 37 or the heated air that enters the frying chamber 51 is released from the flying chamber 51 via the exhaust pipe 71 and the chimney 70 to prevent excessive pressure in the frying chamber 51. Such excessive pressure would expel the pot 37 from the frying chamber 51.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A cooking apparatus comprising:
a cart comprising a control panel and plates connected to the control panel to provide a compartment, wherein the control panel comprises an opening;
a casing comprising an open top, wherein the casing is inserted in the compartment in a non-movable manner;
a top plate covering the open top of the casing to provide a frying chamber in the casing, wherein the frying chamber comprises an entrance in communication with the opening of the control panel;
a protuberance formed on a central portion of the top plate;
a fan located under the protuberance;
a motor connected to the fan and supported on the protuberance;
a burning can attached to the top plate out of the casing in a non-movable manner;
a connective pipe comprising an end connected to the protuberance and another end connected to the burning can;
a burner comprising an end connected to the burning can;
a valve connected to another end of the burner;
a power knob connected to the valve and located out of the control panel; and
an igniter connected to the burning can in the vicinity of the burner, wherein the power knob is operable to actuate the igniter.

2. The cooking apparatus according to claim 1, comprising a blower connected to an internal face of one of the plates, wherein the blower is operable to blow air toward the motor.

3. The cooking apparatus according to claim 2, wherein a regulator electrically connected to the motor and the blower, wherein the regulator is located on an internal face of the control panel.

4. The cooking apparatus according to claim 3, comprising a time knob connected to the regulator, wherein the time knob is located out of the control panel.

5. The cooking apparatus according to claim 1, comprising a grid located below the fan, wherein the motor comprises a mandrel connected to the fan in the protuberance.

6. The cooking apparatus according to claim 5, wherein the grid is inserted in one of the casing and the top plate between the frying chamber and the fan.

7. The cooking apparatus according to claim 1, comprising a pot formed with a front panel covering the opening of the control panel, wherein the pot is movable into the frying chamber via the entrance and the opening.

8. The cooking apparatus according to claim 7, wherein the pot comprises a handle connected to the front panel.

9. The cooking apparatus according to claim 1, comprising a manifold connected to the valve.

10. The cooking apparatus according to claim 1, comprising a chimney connected to the flying chamber.

11. The cooking apparatus according to claim 10, comprising an exhaust pipe comprising an end connected to the frying chamber and another end in communication with an aperture made in one of the plates, wherein the chimney comprises a flange connected to the plate so that the chimney is in communication with the exhaust pipe.
